(19) United States
(12) Patent Application Publication
(10) Pub. No.: US 2016/0358292 A1
(43) Pub. Date: Dec. 8, 2016

(54) SYSTEM FOR MANAGING PATIENT REFERRALS

(71) Applicant: Humana Inc., Louisville, KY (US)

(72) Inventors: Marc Willard, San Jose, CA (US); George Morris, Los Gatos, CA (US)

(73) Assignee: Humana Inc., Louisville, KY (US)

(21) Appl. No.: 14/217,163

(22) Filed: Mar. 17, 2014

Related U.S. Application Data
(60) Provisional application No. 61/799,677, filed on Mar. 15, 2013.

(51) Int. Cl. G06Q 50/22; G06Q 10/10

(52) U.S. Cl. CPC G06Q 50/22; G06Q 10/10

(57) ABSTRACT

The present invention is an apparatus for communicating a patient referral from a first patient care provider to a second patient care provider. Such an apparatus is also configured to communicate patient heath record data from first care provider's electronic health records system to a second care provider's electronic health records system in response to an electronic request from the second care provider.

### CROSS-REFERENCE TO RELATED APPLICATIONS

This application claims priority to provisional patent application 61/799,677, filed on Mar. 15, 2013, which is hereby incorporated by reference in its entirety herein.

### BACKGROUND AND SUMMARY OF THE INVENTION

Exemplary embodiments of the present invention relate generally to a system and method for sharing patient data across a care team comprised of a plurality of medical care providers.

Prior to electronic medical record (EMR) systems, medical records were often kept in paper format in a physician's office or hospital. Folders were maintained for each patient listing patient symptoms, diagnoses, and prescribed drugs or treatments. These paper-based records systems frequently consumed large amounts of storage space, were not easily archived or easily searchable. The introduction of EMR systems allowed a health care provider to gather and store patient medical records in an electronic format that was searchable, easily backed-up, and required much less space than a paper-based record system. As technology advanced, EMR systems became more commonplace in even small medical care providers. The ability to retrieve and search electronic medical records improved the ability of health care providers to provide care to their patients. However, EMR systems are not without their shortcomings. Because there are multiple providers of electronic health care record (EMR) systems, EMRs often are implemented as separate and incompatible systems between care providers. An undesirable result of such separation and incompatibility may be that medical care providers to which a patient has been referred by another medical care provider may not have access to patient data available in the referring medical care provider's EMR system. Unless the medical care provider to which a patient has been referred has access to a copy of the patient's medical record, the referred-to medical care provider may be forced to obtain patient history from the patient during an initial visit. Known methods of providing patient medical records may include the referring medical care provider providing a summary of the referred patient's information to the referred health care provider when the referral is made. Such summaries often may only contain the information that the referring medical care provider deems necessary to provide, and as a result, may not contain information that a referred medical care provider may require in order to develop a full understanding of a patient's condition.

What is needed is a system and method to facilitate the sharing of patient data from referring to referred health care providers. Such a system may display this shared patient data in a manner that presents the data in a standardized format useful to the referred health care provider, thereby allowing the referred heath care provider to more readily interpret and utilize the shared patient data.

Alternatively, the display of shared information may be displayed in a customizable user interface such that the health care provider viewing the shared information may configure the display to present information in a manner most useful to the viewer when in providing the type of heath care for which the patient was referred.

In addition to the novel features and advantages mentioned above, other benefits will be readily apparent from the following descriptions of the drawings and exemplary embodiments.

### BRIEF DESCRIPTION OF THE DRAWINGS

FIG. 1 is an illustration of an embodiment of the invention illustrating referring and referred-to medical care provider EMR systems;

FIG. 2 is an illustration of a plurality of EMR systems and computerized interface devices in an embodiment of the invention;

FIG. 3 is an illustration of a computer device used in an embodiment of the invention;

FIG. 4 is an illustration of a cloud computing implementation of invention;

FIG. 5 is a flow chart of an embodiment of the invention; and

FIG. 6 is an illustration of a screen shot from an embodiment of the invention.

### DETAILED DESCRIPTION OF EXEMPLARY EMBODIMENT(S)

In the following description, specific details such as detailed configuration and components are merely provided to assist the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

An embodiment of the system for managing patient medical records needed for referred-to medical care providers may be created by software configuration of a computerized interface device in communication with at least one other computerized interface device similarly configured. In embodiments of the invention, such computerized interface devices may comprise general purpose computers; computer servers, virtual computers or computer servers created in “the cloud”, or dedicated use computerized interface devices (an “appliance”). Hereinafter, it is assumed that an apparatus for display of patient data from multiple medical care providers according to the present invention are applied to such computerized interface devices.

### Referring and Referred-To System of Nodes

A plurality of EMR systems are currently in use in hospitals, clinics, physician's offices and other health care providers. In one legacy EMR system, patient identifier, data formats, and data storage locations most likely will be different that used in a second legacy EMR system. EMR systems may be costly to purchase and implement and data conversion from one EMR system to another may be especially costly and expose a medical care provider's data to loss or corruption. For these reasons and others, a physician or other medical care provider may be extremely reluctant to change to a new EMR system. As a result, it is unlikely that such a medical care provider will be easily convinced to change systems even to obtain the advantages of the invention described herein. A solution to such a problem is an EMR appliance. Such an EMR appliance be implemented to provide a low-cost approach to enable the sharing of EMR data from one legacy EMR system to another or as illustrated herein, to provide the interface required as part of the system of an embodiment of the invention. An EMR gateway, which is a software embodiment of an EMR appliance, may also be implemented using a software program executing on a computer device such as a computer server or other general purpose computerized hardware device. Unlike the EMR gateway, an EMR appliance is a “sealed system” that is provided in a fully functional state, with little or no setup required.

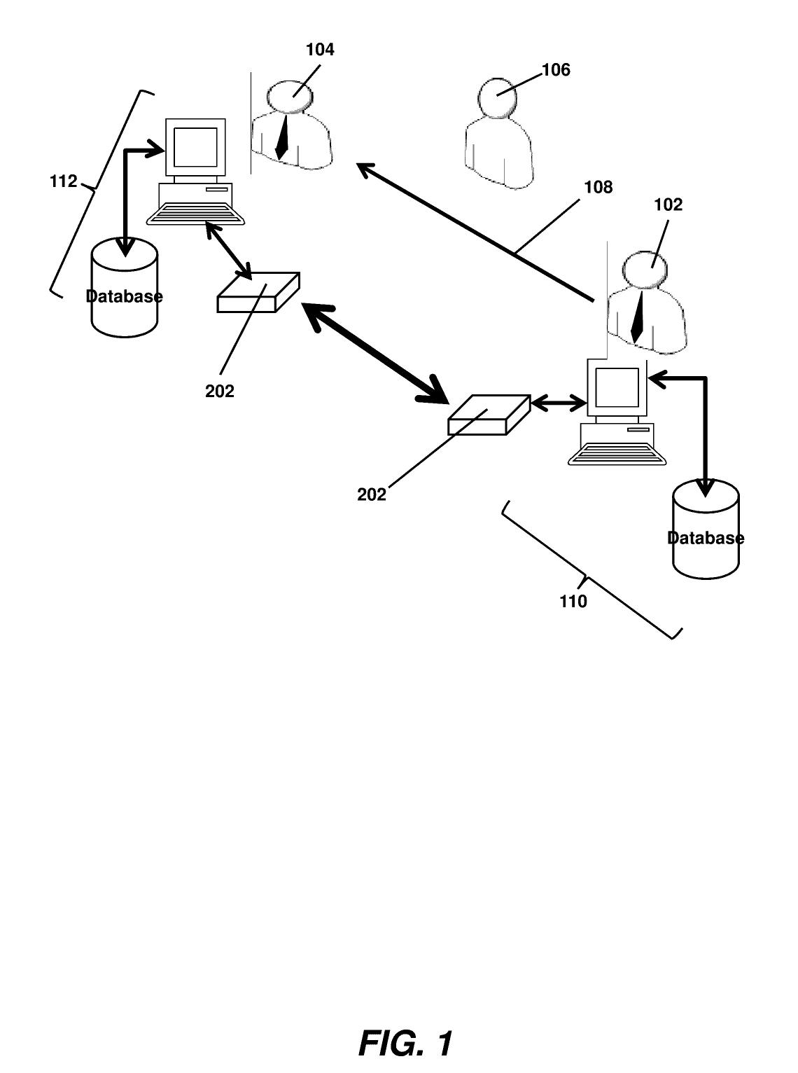

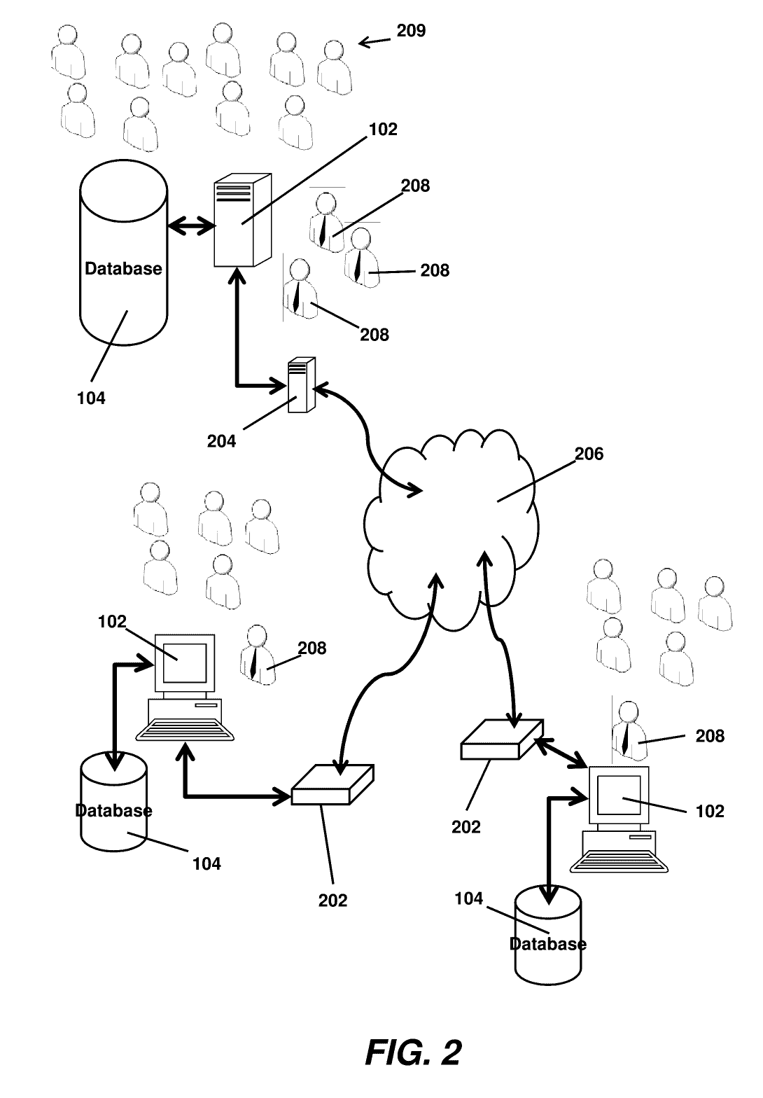

FIG. 1 is a block diagram illustrating a first and a second computerized interface device 202 functioning as an embodiment of the invention described herein. An embodiment of a system as described herein may be comprised of at least two such computerized interface devices. As is illustrated in FIG. 2, an EMR system may be comprised of a database 104 and computer 102. The database 104 may contain patient medical records and the computer may be configured by EMR software to retrieve patient information as desired by a health care provider or other user of the EMR system. Referring to FIG. 2, embodiments of the invention may comprise a plurality of computerized interface devices 202 where such devices may be in electronic communication with the EMR systems of a heath care provider. In such an embodiment, computerized interface devices configured according to the invention may operate such that a health care provider may be the referring or referred to health care provider. Each computerized interface device 202 may be placed in electronic communication with an EMR system, configured to retrieve and send information to and from the EMR system, and to communicate with other computerized interface devices configured to function according to embodiments of the invention.

As is illustrated in FIG. 2, an implement an EMR appliance or gateway may be in electronic communication with a legacy EMR system 102. An EMR appliance may be thought of as having an “EMR side” with which the legacy EMR system is in communication, and a “non-EMR side” which may be in communication with non-EMR systems, examples of which may comprise, data networks, computer servers, computers, or other EMR appliances. In an embodiment of an EMR appliance (or EMR gateway), data identifiers and storage locations from the legacy EMR system may be mapped to a unitary medical record where such data identifiers and storage locations are converted to identifiers and storage locations used in the unitary medical record. As a result, requests for data from a legacy EMR system may be mapped to a predefined common or unitary record structure as they are retrieved from the EMR system by the EMR appliance and made available to the requesting device or system.

Referring to FIG. 2, in embodiments of the invention a computerized interface device 202, may be connected to one or more additional computerized interface devices, where each computerized interface device may be in electronic communication with an EMR system comprised of a computer 102 and electronic database 104. Such EMR systems may be configured using software from disparate providers. As is illustrated, in an embodiment of the invention a plurality of such EMR systems may be placed in electronic communication using computerized interface devices 202 configured using software to facilitate communication between EMR systems to allow patient data to be communicated from a referring medical care provider's EMR system to the referred-to medical care provider's EMR system.

### Computerized Interface Device

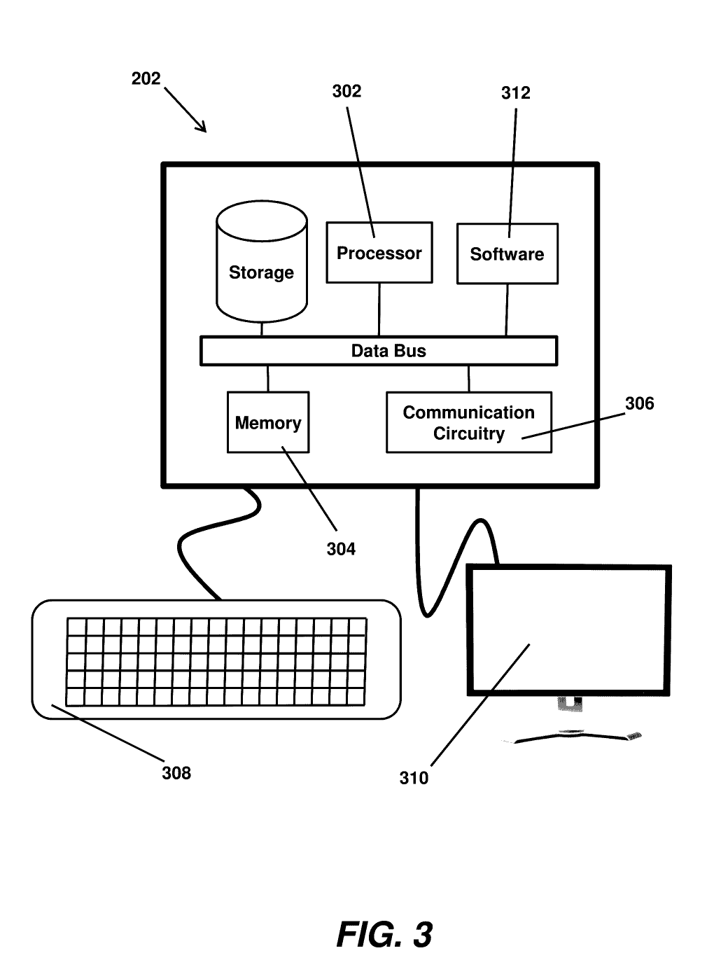

Regardless of whether a computerized interface device is configured to function as an appliance or gateway as is described herein, such a device may comprise similar components. FIG. 3 is a block diagram illustrating a configuration of a computerized interface device according to an embodiment of the present invention.

Referring to FIG. 3, a computerized interface device 202 according to the present invention may comprise a processor 302, a memory 304, and communications circuitry 306 that allows the computerized interface device to communicate with a legacy EMR system and other computerized interface devices configured in an embodiment of the invention.

The processor 302 of the computerized interface device may be configured using software 312 to retrieve information from an EMR system using communications circuitry 306 that is in electronic communication with the EMR system. During such communications, the computerized interface device may retrieve patient data, arrange the data into a format that is readable by other instances of computerized interface devices configured according to the invention (“nodes”), and make that data available to the node or nodes present in an embodiment of the invention.

In embodiments of the invention, computerized interface devices may also include input devices, such as keyboards 308, and output devices, such as computer monitors 310. Such input and output devices may be used to configure or otherwise interact with the computerized interface device as required.

### EMR Appliance

In the case of smaller EMR systems, examples of which may include those EMR systems that support a single medical care provider or small medical practice, embodiments of the invention may be implemented using dedicated purpose computer interface devices. Such computerized interface devices may be designed such that they have limited or no user configurability in order to increase security, decrease maintenance costs, or both. A dedicated device, in contrast to a general purpose computer, may be designed as a closed system. Such a system may be designed to require minimal information technology support beyond initial configuration. Limited configuration may be performed using an interface which may be a terminal console or web-based user interface. Dedicated devices may be less susceptible to security threats than general purpose computers because of their limited configurability and non-standard operating systems. Because of their limited configurability and minimal support requirements, dedicated interface devices are often referred to as appliances.

### EMR Gateway

EMR Gateway servers may be general purpose computers configured to perform the interface functions between EMR systems and other computerized interface devices configured to collectively form embodiments of the invention. In certain embodiments of the invention, gateway servers are placed in electronic communication with larger EMR systems. Gateway servers may offer greater flexibility than devices with less configurability such as EMR appliances described herein and as such may offer better performance with larger EMR systems than may be achieved using less configurable EMR appliance devices. Examples of larger EMR systems may be those systems implemented by hospitals, surgery centers, or large medical care practices where there are multiple care providers accessing medical records. An example is illustrated in FIG. 2. The EMR gateway server 204 is in electronic communication with an EMR system comprised of a database 104 and computer 102. As is illustrated, the EMR system in electronic communication with the EMR gateway 204 may support a larger number of medical care providers 208 and patients 209 than those EMR systems in electronic communication with EMR appliances 202.

### Cloud Based EMR Embodiments

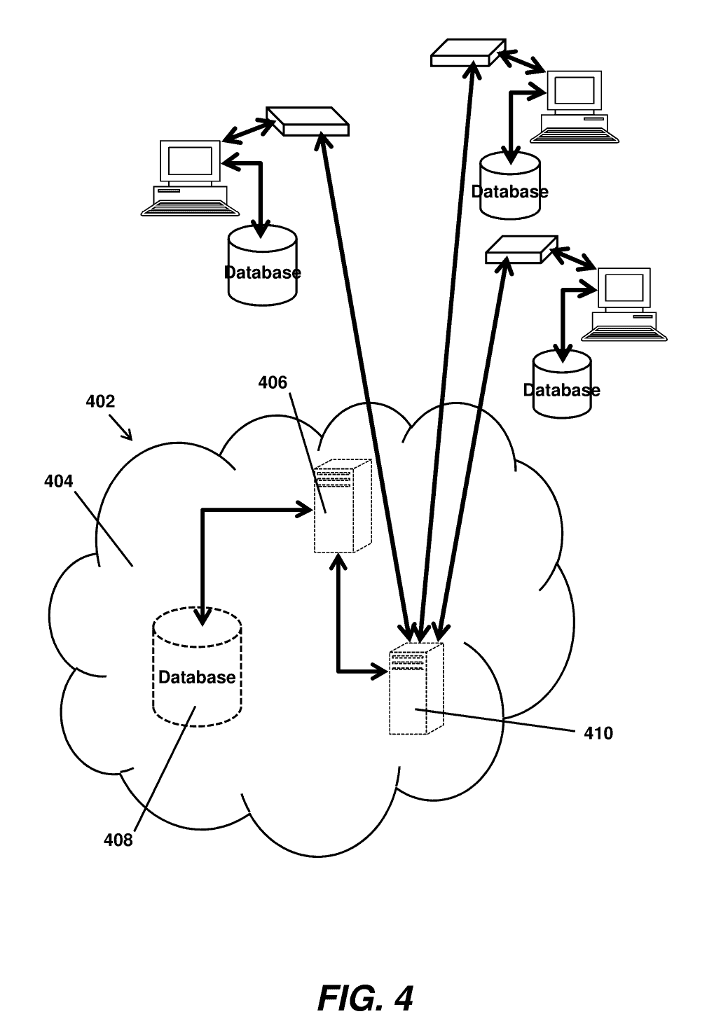

In addition to being implemented using computers 102 and databases 104 as illustrated in FIGS. 1 and 2, EMR systems may also be implemented using cloud computing techniques. In such implementations, databases and computers may be formed using virtual computers located in remote data center facilities. In cloud computing-based embodiments, the computerized interface devices may also be implemented using virtual computers. FIG. 4 illustrates such an embodiment where an EMR system 402 is formed in the cloud 404. In such an implementation, a virtual computer 406 may be formed to execute EMR system software. This virtual computer may be configured to access a cloud based database 408 containing the patient medical records data. To provide an interface in such a configuration, an embodiment of the invention may utilize a virtual EMR gateway 410. Such a virtual gateway may be formed from a virtual computer using software which configures the virtual computer to act as a virtual embodiment of the invention.

Referring to FIG. 2, a plurality of computerized interface devices configured as appliances 202, and gateways 204 may be placed in electronic communication through a computer network 206 to allow the appliances and gateways to communicate with each other and share data that is contained in the various EMR systems with which the appliances and gateways are in communication. In an embodiment of the invention, the computerized interface devices 202 and 204 may be configured to retrieve patient data from other nodes of the invention. These other nodes may be formed from EMR appliances 202 and EMR gateways 204 in electronic communication with various EMR systems.

### Patient Referrals

Due to the specialized nature of medical care, it is common for a medical care provider to refer a patient to another medical care provider that may specialize in the type of care that the referring medical care provider believes that the patient may require. In such a situation, a medical care provider may contact another care provider to arrange such a referral. Referring to FIG. 1, when a medical care provider (the referring medical care provider) 102 seeks to refer a patient 106 to another medical care provider (the referred-to medical care provider) 104 to receive care, the referring medical care provider may contact the referred-to medical care provider and inform the provider that a patient has been referred for consultation, diagnosis, or treatment. This contact is illustrated by the line 108 from the referring medical care provider 102 to the referred-to medical care provider 104.

To facilitate the referred-to medical care provider's 104 provision of medical care to the referred patient 106, the referred-to medical care provider 104 may wish to access the referred patient's medical records located on the referring medical care provider's EMR system 110. To gain such access, in step 502 the referring medical care provider 102 may provide the referred-to medical care provider 104 a unique patient identifier. The referred-to medical care provider 104 may use the unique patient identifier to retrieve patient data from the referring medical care provider's EMR system 110 as well as other EMR systems in electronic communication with computerized interface devices. As is illustrated in FIG. 1, a computerized interface device 202 in electronic communication with the referred-to medical care provider's EMR system 112 may communicate this unique patient identification number as an electronic query to a computerized interface device 202 in electronic communication with the referring medical care provider's EMR system 110. The computerized interface device in electronic communication with the referring medical care provider's EMR 110 system may retrieve patient data from the EMR system and communicate the data to the computerized interface device 202 in electronic communication with the referred-to medical care provider's EMR system 112. Because the computerized interfaces are in electronic communication with EMR system data and in electronic communication with each other through a computer network, the communication of this patient data may occur in substantially real-time. The computerized interface device in electronic communication with the referred-to medical care provider's EMR system 112 may provide data to that EMR system to create or add data to the referred patient's 106 electronic medical record. Such data may assist the referred-to medical care provider 104 in the provision of care to the referred patient 106.

In certain embodiments of the invention, patient data may exist on other EMR systems in addition to the referring medical care provider. Referring to FIG. 2, computerized interface devices configured as EMR appliances 202 and EMR gateways 204 are shown in electronic communication with a plurality of EMR systems. In an embodiment of the invention, an EMR appliance 202 in electronic communication with a referred-to medical care provider's EMR system may communicate a request for data to an EMR appliance 202 in electronic communication with the referring medical care provider's EMR system. Such a request may be communicated using the computer network 206 to which a plurality of EMR appliances and EMR gateways are in electronic communication. An example of such a computer network 206 may be the internet but embodiments of the invention may employ other networks including but not limited to local area networks, wide area networks, wireless networks, and cellular data networks.

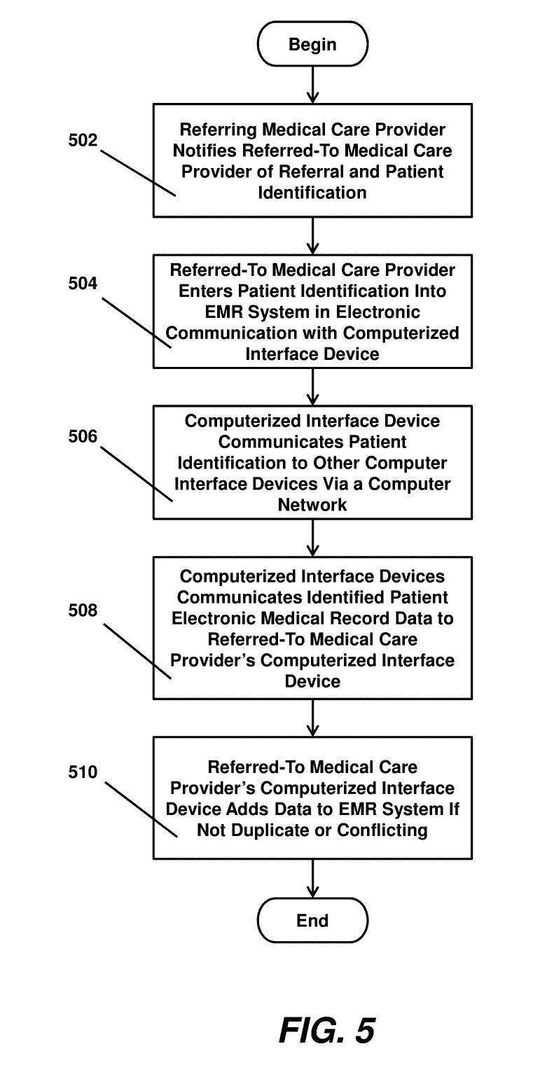

When communicated to a computer network to which a plurality of EMR appliances 202 and EMR gateways 204 are attached, a request for data to an EMR appliance may be received by computerized interface devices in electronic communication with EMR databases in addition to the referring medical care provider's databases. Referring to the flow chart of FIG. 5, in such a embodiment, these additional computerized interface devices may be configured by software to respond to such request for data with patient data if the additional computerized interface devices are in electronic communication with EMR databases that contain data for the referred patient 106 associated with the unique patient identifier. In such an embodiment, the computerized interface device in electronic communication with the referred-to medical care provider's EMR system may receive patient data for a referred patient from a plurality of EMR systems in electronic communication with computerized interface devices comprised in an embodiment of the inventive system. In such an embodiment of the invention, a referred-to medical care provider may benefit from a patient medical record that is available from EMR systems in addition to the EMR system associated with the referring and referred-to medical care providers.

Referring to the flow chart of FIG. 5, a referring medical care provider may notify the referred-to medical care provider of the referral 502 in one or more of a number of ways, including via email, voice mail, call, fax, text, through the EMR system, etc. The referred-to medical care provider may enter the referred patient unique identifier into the referred-to provider's EMR system 504. The computerized interface device in electronic communication with the referred-to medical care provider's EMR system may then communicate the patient identifier to other computerized interface devices using a computer network 506. In an embodiment of the invention, those other computerized interface devices may retrieve the patient's information from EMR systems to which they are in electronic communication and communicate that patient data to the referred-to medical provider's computerized interface device communicating the patient identifier 508. The referred-to medical provider's computerized interface device may compare an existing patient record with the updated information to make sure that the update doesn't already exist or conflict with existing patient information contained within the EMR system. If the update doesn't exist or conflict, the information is added to the patient record in step 510. In this manner, a referred-to medical care provider may access patient information retrieved from EMR systems in addition to the EMR system associated with the referring medical care provider. Once the referred-to medical care provider examines or treats the patient, care data is entered into the EMR and may be communicated across the network to the referring medical care provider's EMR System. In an exemplary embodiment, the patient may chose whether to have his/her care data exchanged among core providers. In this embodiment, a control is activated in the EMR system to prevent the patients data from being forwarded.

### Configurable Display

As was described herein, in certain embodiments of the invention patient data in an EMR system may be updated to reflect new patient information found in EMR systems in addition to the referred-to medical care provider's EMR system, including the referring medical care provider's EMR system and other EMR systems that contain electronic medical records related to the referred patient. The result may be patient information that a referred-to medical care provider would not normally expect to be contained in their EMR system. Despite the fact that this information might not have existed in the EMR prior to the implementation of an embodiment of the present invention and referral by the referring medical care provider, the information may nevertheless be beneficial to the referred-to medical care provider for use in the detection and diagnosis of illnesses or other patient health conditions.

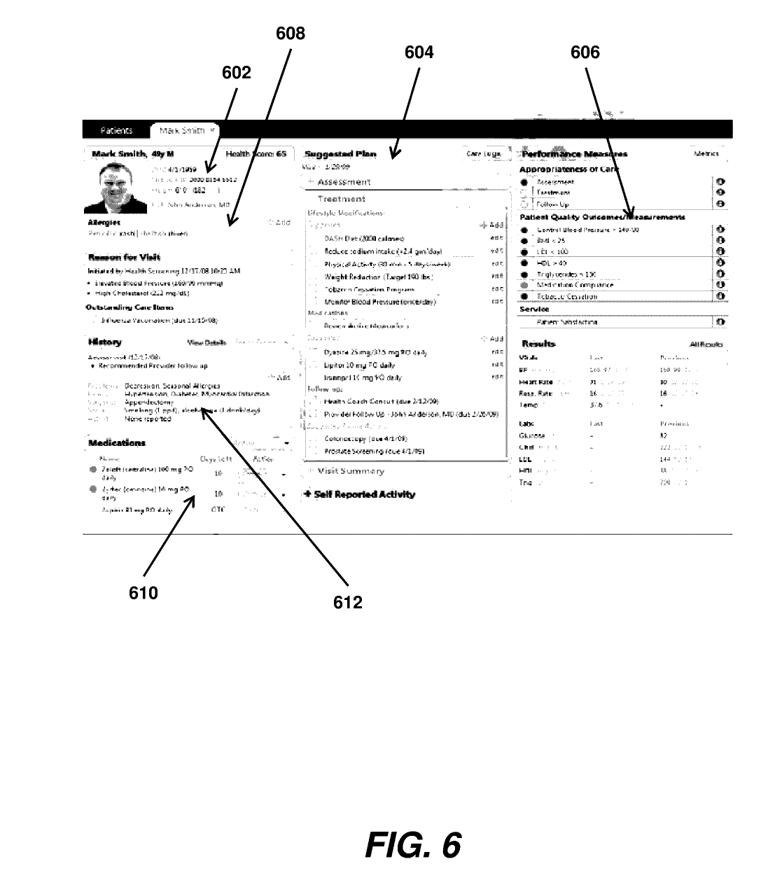

In order to enable the most effective use of this data, a user interface may be configured to provide a standard display interface available to each instance of an EMR gateway, EMR appliance, or application portal connected EMR system. Referring to FIG. 6, such an interface may comprise information such as patient overview data 602, suggested patient care plans 604, patient quality outcomes 606, allergy information 608, medications 610, and summary information related to visits to care providers and care provided 612.

Embodiments of the invention may allow referred-to medical care providers or other users to customize the interface to enhance the user's ability to provide medical care to patients. Specialized medical care providers to which a patient has been referred may have a particular interest in certain aspects of a patient's medical record. To facilitate patient care, such specialists may customize the user interface presented by an embodiment of the invention to highlight certain patient characteristics that are most relevant to the care provided by the specialist.

Because certain patient characteristics may greatly increase the risk that patient when receiving care, embodiments of the invention may be configured to make it more likely that a user will be aware of these patient characteristics by presenting critical patient health record data in a section of the user interface that is centrally located, highlighted, or otherwise set off from the remaining patient data. Certain embodiments of the invention may present this patient data in a consistent location and manner despite user customization of the remaining sections of the user interface.

Any embodiment of the present invention may include any of the optional or preferred features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to the described invention. Many of those variations and modifications will provide the same result and fall within the spirit of the claimed invention. It is the intention, therefore, to limit the invention only as indicated by the scope of the claims.

1. A system for managing medical patient referrals, comprising:
a referring computerized interface device configured to receive entered patient medical data associated with a patient who has been seen by a referring care provider;
a referred-to computerized interface device configured to engage in electronic communications with said referring computerized interface device, said referred-to computerized interface device associated with a referred-to care provider who the patient has been referred to see by the referring care provider, for a particular medical need;
a first set of medical care data about said patient stored in a first electronic medical record by said referring computerized interface device and forwarded electronically to said referred-to computerized interface device; and
a second set of medical care data about said patient generated as a result of said referred-to care provider seeing said patient, stored in a second electronic medical record by said referred-to computerized interface device and forwarded electronically to said referring computerized interface device.

2. The system of claim 1, wherein said first set of medical care data is electronically stored in said first electronic medical record in a first format, the referring computerized interface device further configured to arrange said first set of medical care data into a format that is readable by said referred-to computerized interface device, and said referred-to computerized interface device further configured to store said first electronic medical record in said second electronic medical record in a second format.

3. The system of claim 1, wherein said referring computerized interface device is further configured to receive a unique identifier of said patient from said referred-to computerized interface device, whereby said first set of medical care data forwarded electronically by said referring computerized interface device is identified for forwarding.

4. The system of claim 1, wherein said referred-to computerized interface device is further configured to receive a unique identifier of said patient from said referring computerized interface device, whereby said second set of medical care data forwarded electronically by said referred-to computerized interface device is identified for forwarding in response to the receipt of said unique identifier.

5. The system of claim 1, wherein said referred-to computerized interface device is further configured to generate a user interface for display on a screen.

6. The system of claim 1, wherein said referring computerized interface device is further configured to generate a user interface for display on a screen.

7. The system of claim 5, wherein said user interface comprises a separate section for said display of patient overview data and at least one of suggested patient care plans, patient quality outcomes, allergy information, medications information, and summary information related to visits to care providers and care provided.

8. The system of claim 5, wherein said referred-to computerized interface device is further configured to:
receive user interface customization instructions where said instructions comprise instructions to highlight certain patient information; and
generate said user interface for display on said screen according to said user interface customization instructions.

9. The system of claim 8, wherein said user interface comprises a data section configured to display predetermined patient record data where said section is not subject to said user interface customization instructions.

10. The system of claim 6, where said user interface is configured to display a preselected patient data set.

11. The system of claim 1, wherein said referred-to computerized interface device is further configured to receive a notification of said referral and in response to said notification, transmit an electronic query to a third computerized interface device to provide additional patient data related to said patient and electronically stored in a third electronic medical record.

12. A method of managing a referral of a patient from a referring care provider where the patient is associated with patient data electronically stored within a referring electronic records system, wherein a plurality of computerized interface device programmed with software which configures the processors of each interface device to implement the method comprising the steps of:
receiving at a first computerized interface device, a unique identifier associated with the patient;
transmitting by the first computerized interface device, an electronic query comprising the unique identifier to a second computerized interface device;
retrieving by the second computerized device, patient data from a first electronic medical record in communication with the second computerized device that is identified by the unique identifier, the retrieved patient data in a first format which is used by the first electronic medical record;
converting, by the second computerized device, the patient data in a first format into a second format, where said format is common to the plurality of computerized interface devices;
transmitting from the second computerize device to the first computerized device, the patient data in a second format;
receiving by the first computerized device, the patient data in the second format format from the second computerized interface device;
converting the patient data into a third format where the third format is used by a referred-to electronic medical records system; and
transmitting the patient data in the third format to the referred-to electronic records system for storage.

13. The method of claim 12, further comprising the steps of:
configuring a preselected data set selected from the patient data; and
transmitting the preselected data set for display at a user interface.

14. The method of claim 12, wherein an existing patient record associated with the patient is electronically stored in the referred-to electronic records system, the method further comprising the steps of:
compare the patient data with the existing patient record; and
update the existing patient record with a subset of the patient data that does not conflict with the existing patient record.

15. The method of claim 12, wherein the unique identifier associated with the patient is received from an input device in communication with a computerized interface device.

16. The method of claim 12, wherein the unique identifier associated with the patient is received from the referred-to electronic records system.

17. The method of claim 12, wherein the unique identifier associated with the patient is received from the second computerized interface device.

18. A computerized interface device comprising:
a processor;
memory;
interface circuitry;
software which configures the processor to transmit a notification of a patient referral to another computerized interface device in response to a user input; and
software which configures the processor to automatically retrieve patient information from an electronic medical records system in electronic communication with the computerized interface device, convert the retrieved patient information from a first storage format native to the electronic medical records system into a second storage format which is a predetermined record structure, and transmit the retrieved and converted patient information to at least a second computerized interface device in response to the receipt of a notification of a patient referral from the second computerized interface device.

19. The computerized interface device of claim 18, further comprising software which configures the processor to create a virtual user interface which receives user input.

20. The computerized interface device of claim 18, further comprising software which configures the processor to:
receive patient data stored in the second storage format from another computerized interface device in response to a notification transmitted;
format the received patient data for storage on the electronic medical records system; and
transmit the formatted patient data to the electronic medical records system in communication with the computerized interface device.
